(19) United States
(12) Patent Application Publication
(10) Pub. No.: US 2023/0332901 A1
(43) Pub. Date: Oct. 19, 2023

(54) VEHICLE OFF ROUTE DETECTION

(71) Applicant: Uber Technologies, Inc., San Francisco, CA (US)

(72) Inventors: Shaishav Gandhi, San Francisco, CA (US); Jordan Ponce, Superior, CO (US); Anjini Shukla, San Francisco, CA (US); Roberto Fonti, Arvada, CO (US); Qianyu Xu, San Francisco, CA (US); Wenqi Hu, San Francisco, CA (US); Dylan Babbs, San Francisco, CA (US); Pushkar Prateek, South San Francisco, CA (US); Jasvinder Singh, Newark, CA (US); Yi Lu, Newark, CA (US); Junzhuo Chen, San Mateo, CA (US)

(21) Appl. No.: 17/723,382

(22) Filed: Apr. 18, 2022

(51) Int. Cl. G01C 21/34; G01C 21/36

(52) U.S. Cl. CPC G01C 21/3415; G01C 21/3691; G01C 21/367; G01C 21/362

(57) ABSTRACT

A method of re-routing an off route vehicle is described. A transportation system provides a route from an origin to a destination to a client device associated with a driver of the route. The transportation system receives location data from the client device associated with the driver and calculates one or more error values based on the location data. The transportation system provides a re-route to the client device based on determining that the one or more error values are greater than a threshold value.

### BACKGROUND

In electronic systems that provide navigation routes to drivers, providing a new route to a driver (e.g., re-routing) is sometimes necessary. A re-route may occur, for example, if a driver misses a turn suggested by the electronic system. In some cases, the re-route is a true re-route, meaning that the re-route reflects a mismatch between driver actions and the routing algorithm. In other cases, the re-route is a false re-route caused by inaccurate location data or issues with the routing algorithm. Ideally, an electronic system providing navigation routes would experience no false re-routes. However, optimizing a routing algorithm to minimize false re-routes may introduce a high latency for the routing algorithm. As such, a way of minimizing false re-routes while retaining a low latency is needed.

### SUMMARY

A method of improved off route detection is described. The method decreases the amount of latency (in time and therefore in distance traveled off the route by the driver) between when a driver deviates from a route and when a new route is provided to the driver. The new route provided to the driver is referred to herein as a re-route.

In one embodiment, a method includes the following steps. A route from an origin to a destination is provided to a client device associated with, for example, a driver of the route. Location data is received from the client device, and one or more error values are calculated based on the location data and the provided route. A threshold value for re-routing is determined, and the one or more error values are compared to the threshold value for re-routing. In response to the one or more error values being greater than the threshold value, a re-route is provided to the client device.

### BRIEF DESCRIPTION OF THE DRAWINGS

FIG. 1 illustrates a network environment in which a transportation management system operates in accordance with one or more embodiments.

FIG. 2 illustrates a collection of modules that make up a transportation management system in accordance with one or more embodiments.

FIG. 3 illustrates an example of a driver associated with the transportation management system diverging from a route provided by the system in accordance with one or more embodiments.

FIG. 4A illustrates an example of a driver associated with the transportation management system diverging from a route provided by the system in accordance with one or more embodiments.

FIG. 4B illustrates an example of a driver associated with the transportation management system diverging from a route provided by the system in accordance with one or more embodiments.

FIG. 4C illustrates an example of a driver associated with the transportation management system diverging from a route provided by the system in accordance with one or more embodiments.

FIG. 5 is a flowchart illustrating a method of re-routing an off-route driver associated with the transportation management system in accordance with one or more embodiments.

FIG. 6 illustrates a block diagram of a computer system 600 associated with the transportation management system.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

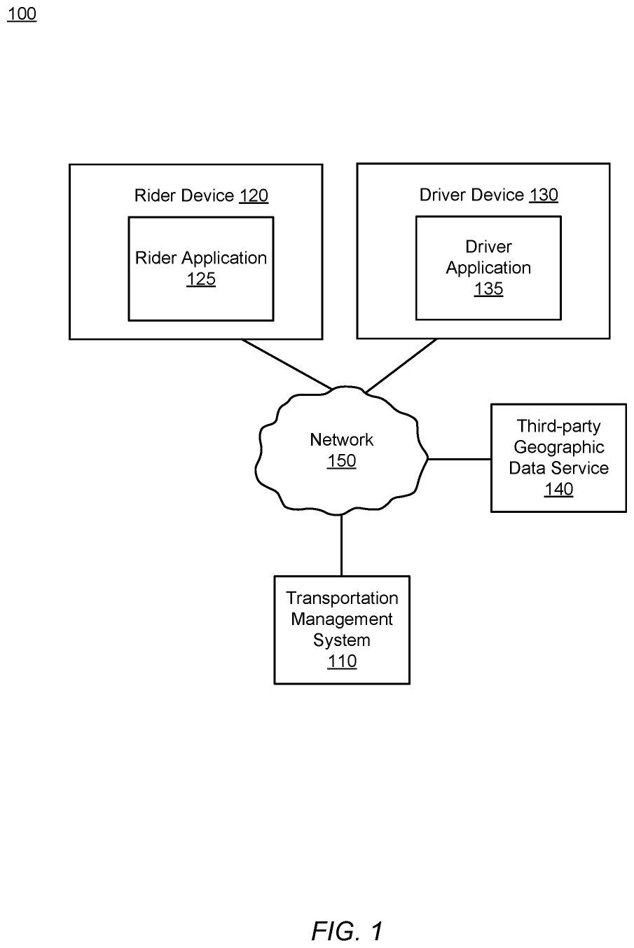

Turning now to the specifics of the system architecture, FIG. 1 illustrates a system environment 100 for a transportation management system 110. In the embodiment shown, the system environment 100 includes a transportation management system 110, a rider device 120, a driver device 130, a third-party geographic data service 140, and a network 150. In other embodiments, the system environment 100 includes different or additional elements. Furthermore, the functionality may be distributed among the elements in a different manner than described.

The transportation management system 110 coordinates the transportation of persons or goods/items for a rider by a service provider (e.g., a driver of a vehicle). The term “rider” is used herein to refer to a user who requests transportation services from the transportation management system 110 to transport themselves, other individuals, or goods/items. As such, a rider is not necessarily transported as part of a trip requested by the rider. The driver uses a vehicle to provide the transportation services to the rider from a pick-up access point (e.g., a pick-up location) to a drop-off access point (e.g., a drop-off location). The transportation management module 110 communicates with the rider device 120 and the driver device 130 in order to facilitate a trip from the pick-up access point to the drop-off access point. For example, the transportation management system 110 may analyze historical trip data, such as by using machine learning or other statistical techniques, in order to identify geographic positions that are at or near locations where riders are frequently picked up or dropped off. For instance, locations with a pick-up or drop-off frequency above a threshold. The access points may be stored in a set of digital map data used by the transportation management system 110 to facilitate trips. The transportation management system 110 may obtain map data directly, such as from the rider device 120 or driver device 130 or may obtain map data from third-party map data providers, such as from the third-party geographic data service 140, as described below.

A rider operates a client device (i.e., a rider device 120) that executes a rider application 125 that communicates with the transportation management system 110. The rider interacts with the rider application 125 using the rider device 120 to coordinate transportation services through the transportation management system 110. For instance, the rider can make a request for a trip from the transportation management system 110, such as a delivery of items, or transportation for the rider or additional persons. The rider application 125 enables the rider to specify access points for a trip, such as a pick-up access point or a drop-off access point for the trip. A pick-up access point or drop-off access point may be a location input by the rider or may correspond to the current location of the rider device 120, such as determined by a global positioning system (GPS) component of the rider device 120, a wireless networking system, or a combination thereof. For purposes of simplicity, as described herein, a pick-up or drop-off access point can include a pick-up or drop-off location, respectively, for a trip which is (i) determined by the rider application 125 (e.g., based on the current location of the rider device 120 using a GPS component), (ii) specified or selected by the rider, or (iii) determined by the transportation management system 110. In some embodiments, the transportation management system 110 recommends one or more access points for a trip to a rider based on historical trip data and environmental characteristics associated with the location of an access point or location of the rider device 120.

According to examples herein, the rider device 120 can transmit a set of data (referred to herein as “service data”) to the transportation management system 110 over the network(s) 150 in response to rider input or operation of the rider application 125. Such service data can be indicative of the rider's interest in potentially requesting a trip (e.g., before actually confirming or requesting the trip). For example, the rider may launch the rider application 125 and specify an origin location or a destination location to view information about a trip before making a decision on whether to request the trip. The rider may want to view information about the average or estimated time of arrival for pick up by a driver, the estimated time to the destination, the price, the available transportation service types, etc. Depending on implementation, the service data can include the geographic position of the rider device 120, information describing an origin or destination location desired by the rider, rider information (e.g., an account identifier), application information (e.g., version number), a rider device 120 identifier or type, etc. According to some examples, each time the rider modifies the origin or destination location, the rider application 125 can generate and transmit the service data to the transportation management system 110.

Once the rider confirms or orders a trip (e.g., transportation between a pick up location and a drop off location) via the rider application 125, the rider application 125 can generate data corresponding to a request for the trip through the transportation management system 110 (i.e., a trip request). Responsive to receiving a trip request, the transportation management system 110 uses information from the trip request to match the rider with a driver among one or more available drivers. Depending on implementation, the trip request can include rider or device information (e.g., a rider identifier, a device identifier), a transportation service type (e.g., vehicle type), a pick-up location, a drop-off location, a payment profile identifier, or other data. The transportation management system 110 selects a driver from a set of drivers, such as based on the driver's current location and status (e.g., offline, online, available, etc.) or information from the trip request (e.g., transportation service type, pick-up location, or drop-off location), to provide the trip for the rider and transport the rider (or other individuals or items) from the pick-up location to the drop-off location. Responsive to selecting an available driver, the transportation management system 110 sends an invitation message to the driver device 130 inviting the driver to fulfill the trip request.

The driver operates a client device that executes a driver application 135 (i.e., a driver device 130) that communicates with the transportation management system 110. The driver interacts with the driver application 135 using the driver device 130 to provide information indicating whether the driver is available or unavailable to provide transportation services to riders. The driver application 135 can also present information about the transportation management system 110 to the driver, such as invitations to provide trips, navigation instructions, map data, etc. In some embodiments, the driver application 135 enables the driver to provide information regarding availability of the driver by logging into the transportation management system 110 and activating a setting indicating that they are currently available to provide trips. The driver application 135 also provides the current location of the driver or the driver device 130 to the transportation management system 110. Depending on implementation, the current location may be a location input by the driver or may correspond to the current location of the driver device 130 as determined by a GPS component of the driver device 130, a wireless networking system, or a combination thereof. The driver application 135 further allows a driver to receive, from the transportation management system 110, an invitation message to provide a trip for a requesting rider, and if the driver accepts via input, the driver application 135 can transmit an acceptance message to the transportation management system 110. The transportation management system 110 can subsequently provide information about the driver to the rider application 125 on the rider device 120. In the same or different embodiment, the driver application 135 can enable the driver to view a list of current trip requests and to select a particular trip request to fulfill. The driver application 135 can also receive routing information from the transportation management module 110. The driver application 135 enables a driver to provide a rating for a rider upon completion of a trip. In one embodiment, the rating is provided on a scale of one to five, five being the maximal (best) rating.

The rider device 120 and the driver device 130 are portable electronic devices such as smartphones, tablet devices, wearable computing devices (e.g., smartwatches) or similar devices. Alternatively, the driver device 130 can correspond to an on-board computing system of a vehicle. Client devices typically have one or more processors, memory, touch screen displays, wireless networking system (e.g., IEEE 802.11), cellular telephony support (e.g., LTE/GSM/UMTS/CDMA/HSDPA, etc.), and location determination capabilities.

The rider device 120 and the driver device 130 interact with the transportation management system 110 through client applications (i.e., the rider application 125 and driver application 135, respectively) configured to interact with the transportation management system 110. The rider application 125 and the driver application 135 can present information received from the transportation management system 110 on a rider interface, such as a map of the geographic region, and the current location of the rider device 120 or the driver device 130. The rider application 125 and the driver application 135 can determine the current location of the relevant device and provide the current location to the transportation management system 110.

The third-party geographic data service 140 is a third-party provider of geographic data including map data, traffic data, or other geographic information. For instance, the third-party geographic data service 140 may be a geographic information system, such as Esri, Google, TomTom, etc. The third-party geographic data service 140 may provide an application programming interface (API) to client systems in order to facilitate request and retrieval of geographic data by the client systems, such as the transportation management system 110.

The network 150 connects the various components of the system environment 100. The network 150 may be any suitable communications network for data transmission. In an embodiment such as that illustrated in FIG. 1, the network 150 uses standard communications technologies or protocols and can include the internet. In another embodiment, some or all of the components of the system environment 100 use custom or dedicated data communications technologies.

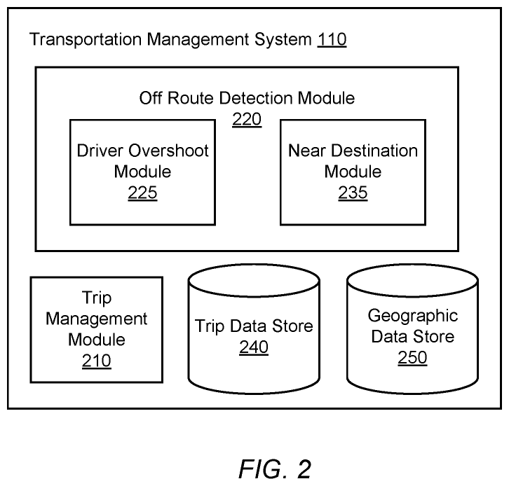

FIG. 2 illustrates an embodiment of the transportation management module 110. In the embodiment shown, the transportation management module 110 includes a trip management module 210, an off route detection module 220, a trip data store 240, and a geographic data store 250. In other embodiments, there may be different or additional components than those shown in FIG. 2. Furthermore, some or all of the operations described for the transportation management module 110 below may be performed on the rider device 120, the driver device 130, or another suitable device. In some embodiments, the off route detection module 220 and its sub-modules are hosted on an application of a client device, such as the driver application 135 or the rider application 125. When hosted on an application, the ORDM 220 communicates with the transportation management system 110 via the network 150.

The trip management module 210 is configured as a communicative interface between the rider application 125, the driver application 135, and the various modules and data stored in the transportation management system 110, and is one means for performing this function. The trip management module 210 receives driver availability status information and current location information from the driver application 135 and updates the trip data store 240 with the availability status. The trip management module 210 also receives trip requests from the rider application 125 and creates corresponding trip records in the trip data store 240. According to an example, a trip record corresponding to a trip request can include or be associated with a trip ID, a rider ID, a pick-up access point, a drop-off access point, a transportation service type, pricing information, a status indicating that the corresponding trip request has not been processed, a trip duration, a trip route, a trip pick-up time, a trip drop-off time, and any other trip data described below with reference to the trip data store 240. According to one example, when a driver accepts the invitation message to service a trip request for a rider, the trip record can be updated with the driver's information as well as the driver's location and the time when the trip request was accepted. Similarly, location and time information about the trip as well as the cost for the trip can be associated with the trip record.

In one embodiment, during execution of a trip, the trip management module 210 receives information (e.g., periodically) from the driver application 135 indicating the location of the driver's vehicle or telematics information (e.g., indications of current speed, acceleration/deceleration, events, stops, and so forth). The trip management module 210 stores the information in the trip data store 240 and can associate the information with the trip record. In some embodiments, the trip management module 210 periodically calculates the driver's estimated time of arrival (DETA) at the pick-up location and provides the DETA to the rider application 125.

As the driver navigates a route to pick up or drop off a rider, the driver may deviate from the route, causing the route to the destination to need to be re-calculated and a new route provided to the driver. The off route detection module (ORDM) 220 receives information from the driver application 135 including telematics data and the location of the driver's vehicle. The ORDM monitors the information to determine if the driver has deviated from the route (e.g., gone off route). The ORDM 220 calculates an error value based on the telematics data. The error value may be the output of an error function having one or more error variables. For example, an error function may include a variable for position error representing a distance between an expected position of the vehicle and an actual position of the vehicle and a variable for heading error representing an angle between an expected heading of the vehicle and an actual heading of the vehicle. The ORDM 220 may set a threshold value for the output of the error function such that when an error value (e.g., the output of the error function) is above the threshold value, the ORDM 220 detects an off route occurrence. In some embodiments, the threshold value may be a predetermined constant that is the same across all trips and is set by ORDM 220. In other embodiments, the threshold value is set by the ORDM 220 using a guess-and-check method. For example, the ORDM 220 sets an initial threshold value for a number of trips and determines, using trip data across the number of trips, if the initial threshold value needs adjusting to increase or decrease the frequency of re-routes. In some embodiments the threshold value is set and monitored by an administrator of the transportation management system 110. The threshold value may be set according to a factors of the provided route such as an average speed limit of the route, a length of the provided route, and types of roads (e.g., single lane routes, alleyways, highways, interstates, etc.) included in the provided route.

An off-route occurrence may be detected, for example, if the driver misses a turn suggested by an original route or takes a wrong turn. In another case, an off-route occurrence may be detected if the trip management module 210 provides a route that includes a road that is temporarily closed. In this example, the ORDM 220 will detect an off-route occurrence when the driver takes a detour around the closed road. The ORDM 220 provides a new route (e.g., a re-route) to a user interface (UI) of the driver device once an off-route occurrence has been detected. Detecting an off-route occurrence, in some methods, may comprise checking the distance between the location of the driver device and the original route to determine if the distance is over a threshold value. If the distance is over a threshold value, an off-route occurrence is detected and the ORDM 220 provides a re-route to the UI of the driver's device.

However, using only the distance between the driver's client device and the provided original route may incur significant error, resulting in false re-routes. Another issue is that there may be a large latency between when a divergence from the provided route occurs (e.g., the time when a driver makes an incorrect turn) and when the ORDM 220 detects the occurrence (e.g., when the system determines that the location of the driver's device is over a threshold distance away from the provided route). This latency may cause additional wrong turns by the driver due to the route not being updated in time for the driver to correct their trajectory.

To decrease the incidence of false re-routes and reduce the latency, an error function for determining an off-route occurrence is bolstered with additional parameters. In one example, the error function is represented by:

αD+βH=γ (1)

wherein D and H represent the distance and heading error respectively, α and β are scaling constants with units inverse of D and H respectively (e.g., if D is measured in feet, α has units of

$$\frac{1}{feet} ) ,$$

and γ is a unitless error value. The output γ of the error function (e.g., the error value) is compared to a threshold value to determine an off-route occurrence. If the error value is greater than the threshold value a re-route is triggered. In this example of the error function, it is possible that if the heading error H is 0, the distance error D may be high enough to cause the output γ to be above the threshold value. The inverse situation in which the distance error D is 0 but the heading error H is high may also cause the output γ to be above the threshold value. In both of these situations a re-route will be triggered even though only one error term is contributing to the error function. The error function used by the transportation management system 110 may include additional terms and use more complex operators rather than being a linear combination of the error terms.

The threshold value is tuned by the transportation management system 110 to allow for noisy data. For example, noisy telematics data may show a driver location as being 15 feet away from the provided route or having a 3 degree heading error, neither of which are above a threshold value that will trigger a re-route. In some embodiments, the error function is dependent on heading and position error variables. The heading error variable represents a difference in heading (e.g., direction) between the movement of the driver's device and the provided route. Including a heading term allows, for example, the ORDM 220 to detect an off-route occurrence caused by a driver taking an incorrect exit off of a highway. While the exit may lead to a road that is within the threshold distance between the route and the driver's location (e.g., does not cause the position error variable to increase greatly), the ORDM 220 will detect the off route occurrence based on the angle of the exit being non-parallel to the provided route, causing an increase in the heading term. The heading term may be a constant representing an angle between the provided route and the driver's trajectory, or the term may be calculated by a function. A function for calculating the heading term may include, for example, an error term or normalization factor. The error term and/or normalization factor may reduce incidence of false re-routes by preventing the heading term from going above a threshold value from heading changes that do not deviate from the route, such as lane switches or pulling over.

In some embodiments the error function for determining an off-route occurrence includes additional terms. The additional terms may include velocity and acceleration of the client device based on change in location data over time.

The driver overshoot module (DOM) 225 detects a specific kind of off-route occurrence associated with a driver going past (e.g., overshooting or being at a location that is beyond the destination based on the direction of approach of the driver's vehicle) a destination. For example, the destination may be the pick up location of a rider. In some embodiments, the DOM 225 is only active when a driver is picking up a rider at a destination. For example, a driver may be directed by the transportation management system 110 along a route from the driver's current location to pick up a rider at a destination. If the driver drives past the pick up location, the DOM 225 raises the threshold value, making an immediate re-route less likely. Additionally, upon detecting the driver has overshot the destination, the DOM 225 provides a prompt to the client device of the driver. The prompt provides the options of pulling over at a nearby safe position or being re-routed back to the destination. In some situations, being re-routed back to the destination may cause significant and unwanted increase in the trip time such as if the driver would have to wait at a traffic light and take a U-turn to get there. In those situations, the driver may pull over at a nearby position and choose the pull-over option on their client device. Responsive to the driver indicating that option, the DOM 225 generates a notification on the client device of the rider being picked up. The notification to the rider provides a walking route from the original pick up location (e.g., the rider's current location) to the location at which the driver has pulled over. If the driver chooses the option of being re-routed to the destination, the DOM 225 provides a route from the driver's current location to the destination and notifies the rider of an updated predicted pick up time based on the route provided to the driver.

In some embodiments, when the DOM 225 determines that the driver has passed the pick up location, the DOM 225 provides the driver with a new destination to stop at. This new destination may be a safe spot nearby for the driver to pull over. For example, the DOM 225 may use the telematics data received from the client device of the driver to determine that the driver is currently on a 4 lane main road with a speed limit of 45 miles per hour (mph). The DOM 225 may choose a new destination within a short distance (e.g., 0.2 miles or less) of the current position of the vehicle that the DOM 225 deems safer to pull over on. In this example, the DOM 225 may instruct the driver to take the first right off of the main road onto a two lane local road with a 25 mph speed limit as the local road is safer for the driver to pull over on and safer for the rider to walk along if necessary. Once the DOM 225 determines, via the location data of the client device of the driver, that the driver has stopped the vehicle at the new destination, the DOM 225 provides a prompt to the client device of the driver with options to stay at the new destination and have the rider walk to them or to receive a re-route back to the original pick up location. The implementer may tune these example values as desired, depending on local conditions and implementer preference.

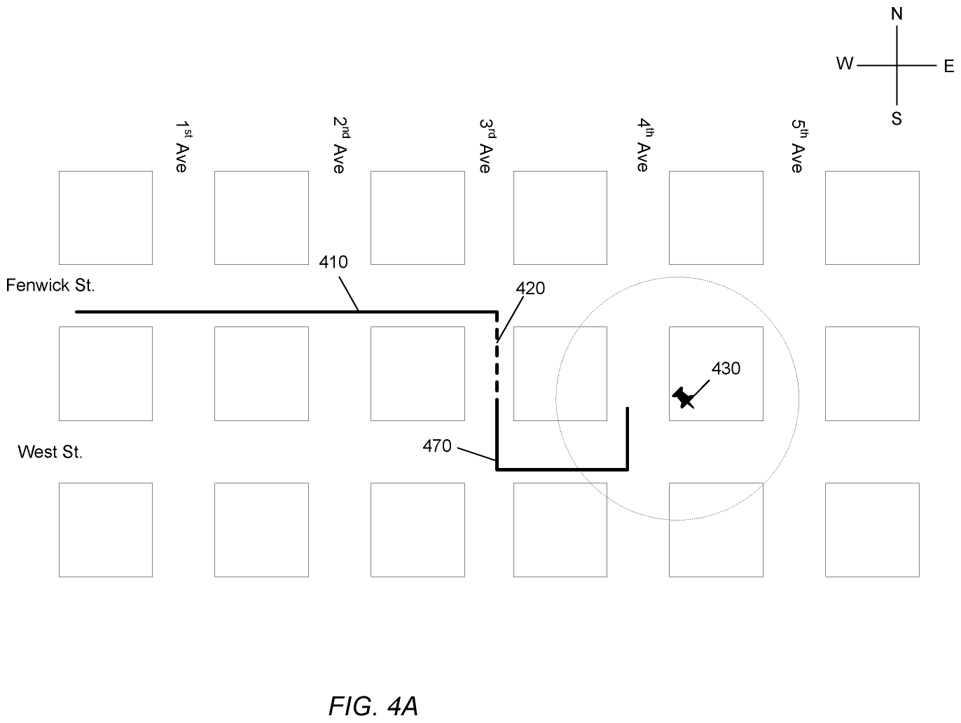

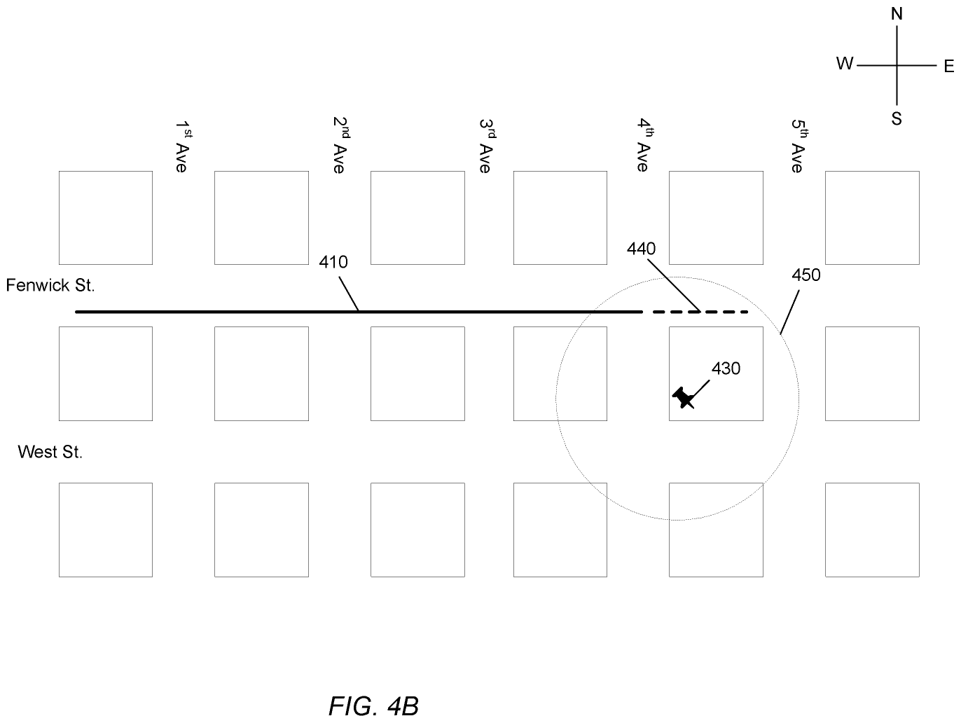

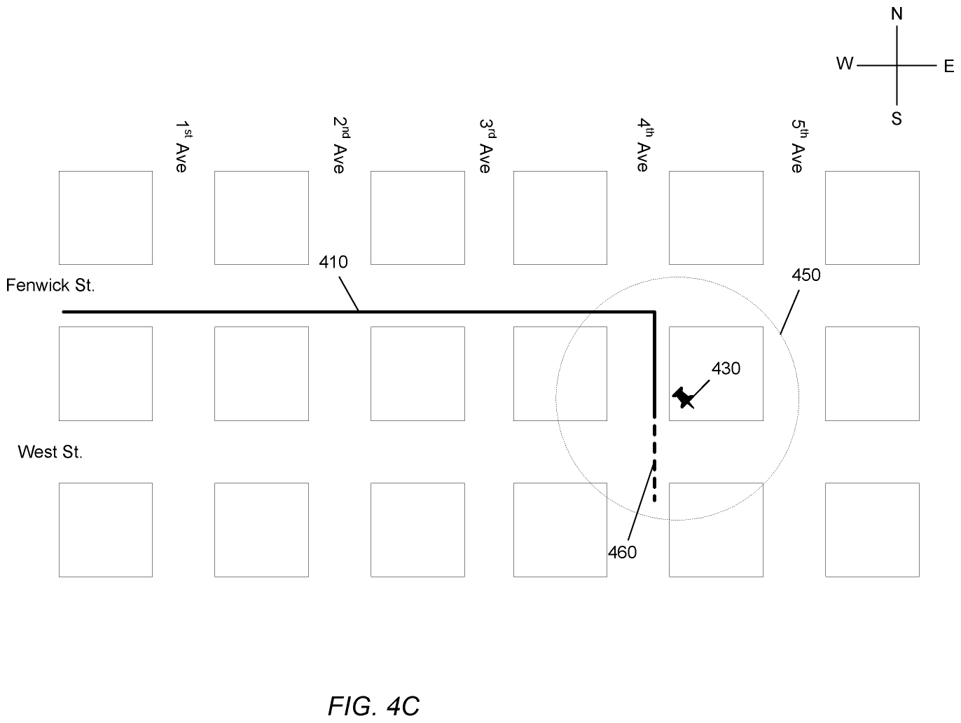

In situations where a vehicle has gone far past the pick up location and is now outside of a threshold distance of the pick up location (e.g., has gone outside the threshold proximity 450 shown in FIG. 4C) the DOM 225 will not, in some embodiments, provide a prompt to the driver as discussed above. Instead, the ORDM 220 will provide a re-route to the client device of the driver back to the original pick up location. In some embodiments when the DOM 225 detects an overshoot that has gone outside of the threshold distance, the DOM 225 will communicate with the ORDM 220 for the ORDM to provide a re-route back to the original pick up location but indicate that the driver can pick up the rider on the opposite side of the street since the driver will now be traveling the opposite direction than the original route to the pick up location.

The DOM 225 may not provide the above-described options to the driver in all cases. In some situations, the rider may indicate, via the rider application 125, that they are unable to walk to a different location due to, for example, limited mobility. This indication by the rider may be made while requesting the trip or prompted by the system at the time of the driver overshoot. In some cases, it may not be safe to ask the rider to walk to the current location of the driver. For example, the walking route from the pick up location to the driver's current location may require the rider to cross a highway. In these examples, the DOM 225 provides a re-route from the driver's current location to the pick up location.

The DOM 225 may set a threshold distance for how far a driver may overshoot the destination and be given the option to request for the rider to walk to them. For example, the threshold distance may be 0.2 miles or less. If the driver overshoots the destination beyond the threshold distance the DOM 225 will automatically provide a re-route for the driver to get back into the threshold distance of the destination. The DOM 225 may then provide a prompt to the driver allowing the driver to choose to pull over at their current location within the threshold distance or continue to the destination.

In some embodiments the threshold distance is manually tuned by an administrator of the system, while in other embodiments a function may be used to automatically calculate the threshold distance for each trip. The threshold distance may be based on factors such as a measure of how urban the area is. For example, in cities the threshold distance may be shorter, while in rural areas the threshold distance may be longer. Another factor for the threshold distance may be the weather, such as automatically decreasing the threshold distance if it is raining or snowing. Other factors such as terrain, time of day, and events may affect the determination of the threshold distance. The threshold distance is automatically determined, set, and updated based on the above-described factors.

The near destination module (NDM) 235 of the ORDM 220 handles cases of off-route detection that occur when a driver is near a destination, where the destination is the drop off location of a rider. The NDM 235 receives location data from the ORDM 220 and determines a proximity of the driver's client device to the destination. In response to the NDM 235 determining that the driver is within a threshold proximity of the destination, the NDM 235 raises the threshold value that the error value must overcome to determine an off-route occurrence. In other words, when a driver is within a threshold proximity of the destination, the ORDM 220 is less likely to issue a re-route to the client device of the driver. For example, when close to a destination, a rider in a car may ask the driver to drop them off at a specific location that is slightly different than the destination. With the NDM 235, going to the rider's specified location rather than the destination will not trigger a re-route.

The threshold proximity associated with the NDM 235 is determined based on characteristics of the drop off location. For example, if the drop off location is in an urban area (e.g., with a high population density and/or a high number of possible routes to the drop off location) an apartment complex, or a neighborhood the threshold proximity may be raised to capture a larger area. For example, a rider may indicate in an application 125 associated with the transportation management system 110 that they'd like to be dropped off at an apartment complex. In this example, the rider may choose the address of the leasing office of the apartment complex as the drop off location, but the rider actually wants to be dropped off nearest to the specific building they live in. Raising the threshold proximity to include the whole apartment complex allows for the rider to verbally instruct the driver to which specific building they'd like to be dropped off at without the driver being issued unnecessary re-routes throughout the complex to get back to the leasing office.

The trip data store 240 maintains data describing riders associated with rider devices 120 (e.g., a rider account), drivers associated with driver devices 130 (e.g., a driver account), records of each in-progress and completed (i.e., historical) trip coordinated by the transportation management system 110, and any other data relevant to trips of facilitated by the transport management system 110. In some embodiments, the trip data store 240 may include multiple data stores for storing one or more specific types of data. Regarding in-progress and completed trips, each trip provided by a driver to a rider is characterized by a set of attributes (or variables), which together form a trip record that is stored in the trip data store 240. The attributes describe aspects of the driver, the rider, and the trip. In one embodiment, each trip record includes a trip identifier (ID), a rider ID, a driver ID, the origin location, the pick-up location, the pick-up spot, the destination location, the duration of the trip, the service type for the trip, estimated time of pick up, actual time of pick-up, and driver rating by rider, rider rating by driver, price information, market information, and/or other environmental variables as described below. In some embodiments, the trip record also includes rider and/or driver feedback regarding the pick-up spot. The variables for the trip record can therefore be drawn from multiple sources, including a rider or drivers usage history of the rider or driver application 135, respectively, or specific variables captured and received during each trip.

Regarding data describing drivers, the trip data store 240 stores account and operational information for each driver who participates in the transportation management system 110. For each driver, the trip data store 240 stores one or more database records associated with the driver, including both master data and usage data. In some examples, master data for a driver includes the driver's name, driver's license information, insurance information, vehicle information (year, make, model, vehicle ID, license plate), address information, cell phone number, payment information (e.g., credit card number), sign-up date, driver service type (regular, luxury, van, etc.), device type (e.g., type of cell phone), platform type (e.g., iOS, Android), application ID, and/or application version for the driver application 135).

The trip data store 240 can further store driver availability status information received from the trip management module 210, including whether the driver is available for matching and the location of the driver (which gets updated periodically). When the trip management module 210 receives a transportation request, the trip management module 210 determines, from the trip data store 240, which drivers are potential candidates to pick up the rider for the newly created trip. When the transportation management system 110 marks a trip record as complete, the transportation management system 110 can add the driver back into an inventory of available drivers in the trip data store 240).

The geographic data store 250 stores geographic data used by the transportation management system 110 to facilitate trips. For instance, the geographic data store 250 may store map data, traffic data, access point data, or other geographic information (e.g., received from the third-party geographic data service 140).

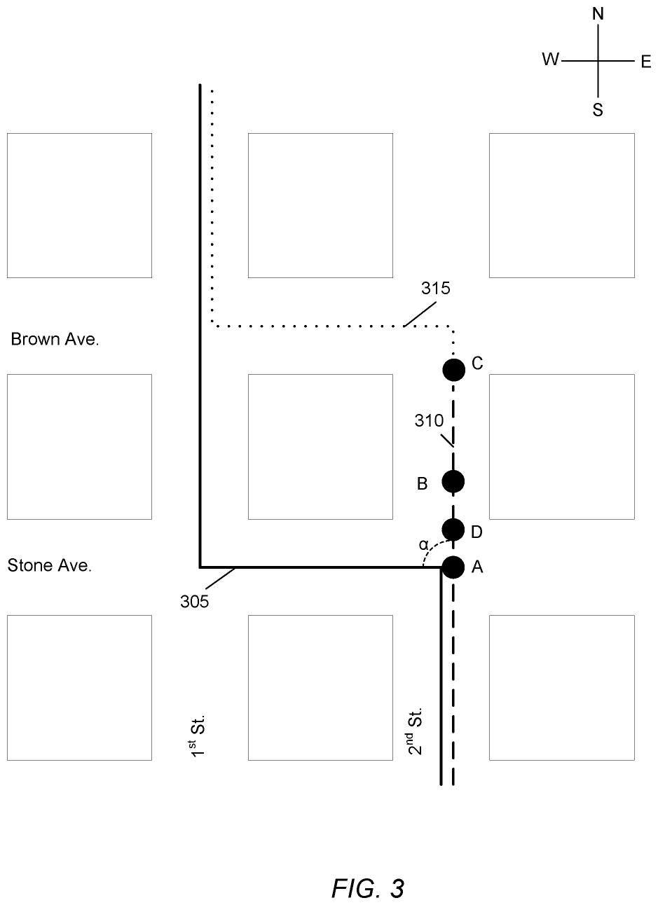

FIG. 3 illustrates an off-route occurrence and a re-route. A driver is traversing a provided route 305. The provided route 305 is represented by the solid line, while the driver's actual route 310 is the dashed line. The driver follows the provided route 305 north on 2^{nd} street. At the intersection of 2^{nd} street, the driver misses the left turn onto Stone Ave at point A, and the driver proceeds north. In this example the off-route detection module 220 may only be using a position error function to detect off-route occurrences. As such, at point A the ORDM 220 does not yet detect the off-route occurrence. As the driver continues north on 2^{nd} St. to point B, the driver is then above a threshold distance away from the provided route 305, and the ORDM 220 detects an off route occurrence. The ORDM 220 uses the location data received at point B to calculate a re-route 315. As the ORDM 220 calculates, the driver continues north on 2^{nd} St. Once the driver reaches point C the ORDM 220 has calculated the re-route 315 and provides the re-route 315 to the driver. The re-route indicates that the driver should take a left onto Brown Ave. The driver follows the re-route 315 to proceed to the destination. The preceding example demonstrates a relatively high latency between when the divergence from the provided route 305 occurs at point A to when it is detected at point B and a re-route 315 is provided at point C. The driver is given very little time between point C and when they need to turn left onto Brown Ave. which may cause another off-route occurrence.

By including a heading term in the error function, the off-route occurrence may be detected instead when the driver is at point D, as the heading error α is approximately 90 degrees. Then, a re-route may be provided by point B. The heading error α will go high between points A and D and the position term will also increase to overcome the threshold error value and indicate an off-route occurrence. By providing a re-route 315 at point B, the driver has ample time to get into the correct lane to take the left turn onto Brown Ave and is less likely to need an additional re-route.

FIG. 4A illustrates an example of a driver associated with the transportation management system 110 diverging from a provided route 410 in accordance with one or more embodiments. In the shown example a driver is navigating a provided route 410 going east on Fenwick St toward a destination 430 on the corner of 4^{th} Ave. and West St. In a first example, the driver takes an incorrect right turn and causes an initial off off-route occurrence 420 to be detected by the off route detection module 220. As the driver continues driving south on 3^{rd} Ave. the ORDM 220 determines if the driver is within a threshold proximity 450 of the destination 430 or if the driver has overshot the destination 430. In this example, the driver's location does not satisfy either of those conditions to activate the driver overshoot module 225 or near destination module 235. As such, the ORDM 220 provides a first re-route 470 to the driver for the driver to reach the destination 430.

FIG. 4B illustrates an example of a driver associated with the transportation management system diverging from a route provided by the system in accordance with one or more embodiments. A driver with a rider goes east on Fenwick St down on the provided route 410 toward the rider's drop off destination 430. The driver misses the right turn onto 4^{th} Ave, continuing east on Fenwick St and the ORDM 220 detects a second off route occurrence 440. The ORDM 220 determines that the driver has not overshot the destination 430 but is within a threshold proximity 450 of the destination 430 and activates the NDM 235. The NDM 235 raises the threshold value for issuing a re-route since the driver is within the threshold proximity 450 of the destination 430. The allows the driver to drop off the rider at the corner of 5^{th} Ave. and Fenwick St. without being issued a re-route.

FIG. 4C illustrates an example of a driver associated with the transportation management system diverging from a route provided by the system in accordance with one or more embodiments. A driver is going to pick up a rider at destination 430 and is driving east on Fenwick St. following the provided route 410. The driver correctly takes the right turn onto 4^{th} Ave but overshoots the destination 430. The ORDM 220 detects a third off-route occurrence 460 and determines that the driver as overshot the pick up destination 430 but not gone outside of a threshold proximity 450, activating the DOM 225. The DOM 225 provides a prompt to the client device of the driver indicating options that the driver may pull over at a nearby safe location or choose to be re-routed back to the pick up destination 430. If the driver chooses to pull over at the SE corner of 4^{th} Ave and West St. the DOM 225 will provide a prompt to the rider who is waiting for pick up at destination 430 indicating that the rider should cross West St. and meet the driver at the SE corner of 4^{th} and West for pick up.

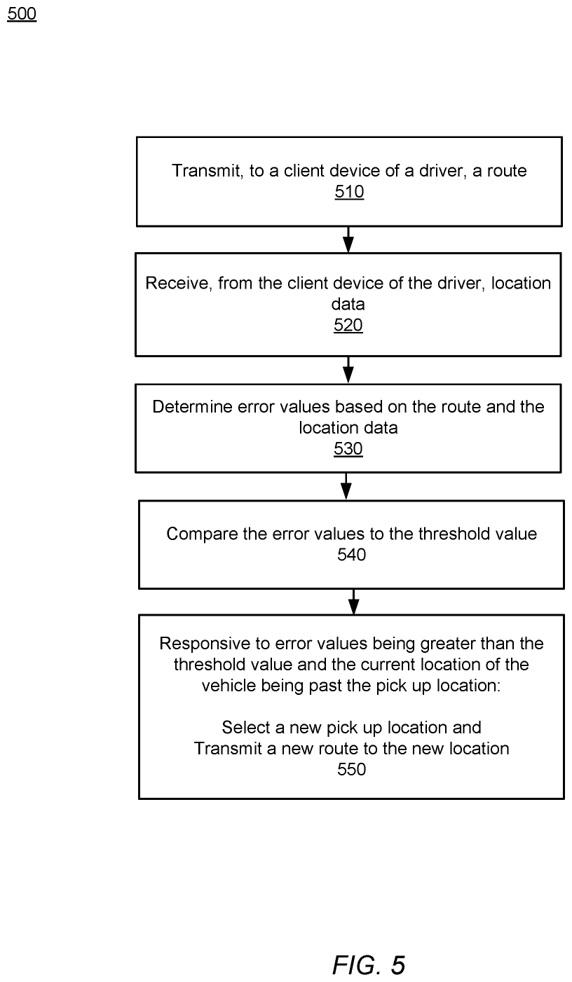

FIG. 5 is a flowchart illustrating a method 500 for re-routing an off-route driver associated with the transportation management system 110 in accordance with one or more embodiments. The method 500 is performed by the off route detection model 220 and its sub-modules. In some embodiments, the method 500 may include fewer steps or have additional steps. It will be obvious to a person of skill in the art that some steps described herein may be performed in different orders than described here or in parallel.

The ORDM 220 transmits 510 a route to the client device of a driver. In some embodiments, the ORDM 220 receives the route from the trip management module 210. The route connects an origin location, such as the original location of the client device of the driver, to a destination location, such as a pick up or drop off location requested by a rider. In one example, the route is optimized by the transportation management system 110 to be the shortest distance between the origin and destination, the fastest route, a route that avoids tolls, a route that uses the least gasoline, among other methods of optimization. Once the route is determined, the route is transmitted via a mobile network to the client device associated with the driver. In some embodiments, the route is displayed in an application associated with the transportation management system 110 that is accessible by the client device.

The ORDM 220 receives 520 location data from the client device associated with the driver. The location data indicates a current location of the vehicle. The location data may include items such as GPS coordinates, a speed of travel, direction of travel, acceleration, and identifier of the client device. In some embodiments, the location data is transmitted from the client device to the transportation management system 110 periodically, such as once per minute, while in other embodiments the location data is transmitted more continuously.

The ORDM 220 determines 530 one or more error values based on the provided route and the received location data. In some embodiments, the error values are the output of error functions, where the inputs to the error functions are variables indicating a heading error and a position error. The error function(s) comprise linear combinations of the error variables or other mathematical operations on the error variables.

A heading error is an indication of the difference of a direction in which a client device is traveling versus an expected direction of travel based on the provided route. For example, if the provided route indicates a travel path north but the client device is traveling north north-east, the heading error is calculated to be 22.5 degrees.

A position error indicates a difference in position between the current location of the client device and the expect location along the route. In one example, the position error is represented by a distance (e.g., in feet, yards, or meters) between the provided route and the current location data.

In some embodiments, the ORDM 220 additionally determines a threshold value for re-routing. In one example, a re-route is only provided if an error value is above the threshold value. The threshold value may be a constant across many trips of the transportation management system 110 or dependent on a number of factors. Factors that change the threshold value include the speed a client device is traveling along the route, a geography of the route, a client device's progress along the route, a client device's position relative to the origin, a client device's position relative to the destination, and the like. For example, the near-destination module 235 raises the threshold value when the client device is detected to be near (e.g., within a predefined distance of) the destination to prevent unnecessary or confusing re-routes near the drop off or pick up location. In another example, the threshold value changes depending on a type of road upon which the client device is traveling. For example, the threshold value may be low for travel along a single lane road and higher for travel along a multi-lane highway because the driver can be considered to be on-route regardless of the lane they travel in along the highway but is considered off route if they travel along different road that is parallel to the single lane road.

The ORDM 220 compares 540 the one or more error values to the threshold value for re-routing to determine if an off-route occurrence has happened. For example, the ORDM 220 compares the one or more error values to determine whether or not the one or more error values is higher than the threshold value. If the one or more error values is higher than the threshold value, the ORDM 220 determines that an off-route occurrence has happened. In some embodiments, the comparison of the threshold value and error value may depend on a more complex mathematical function such as a piecewise function having additional variables or a linear combination applying scaling factors to the error value and threshold value.

If the one or more error values is greater than the threshold value, the ORDM 220 determines if the current location of the vehicle is past the pick up location. If so, the ORDM 220 selects a new pick up location. In some embodiments, the new pick up location is the current location of the vehicle. In another embodiment the ORDM 220 selects a new pick up location based on previous pick up locations used by the transportation management system 110, such as the closest known pick up location to the current location of the vehicle. The transportation management system 110 generates a route between the new pick up location of the client device and the destination. In some embodiments, the transportation management system 110 predicts a future location of the client device based on the received location data and sets the origin location (e.g., starting location of the vehicle) of the re-route at the future location. Once the transportation management system 110 generates the new route, the ORDM 220 transmits the new route to the client device associated with the driver so that the driver may follow the new route to the destination.

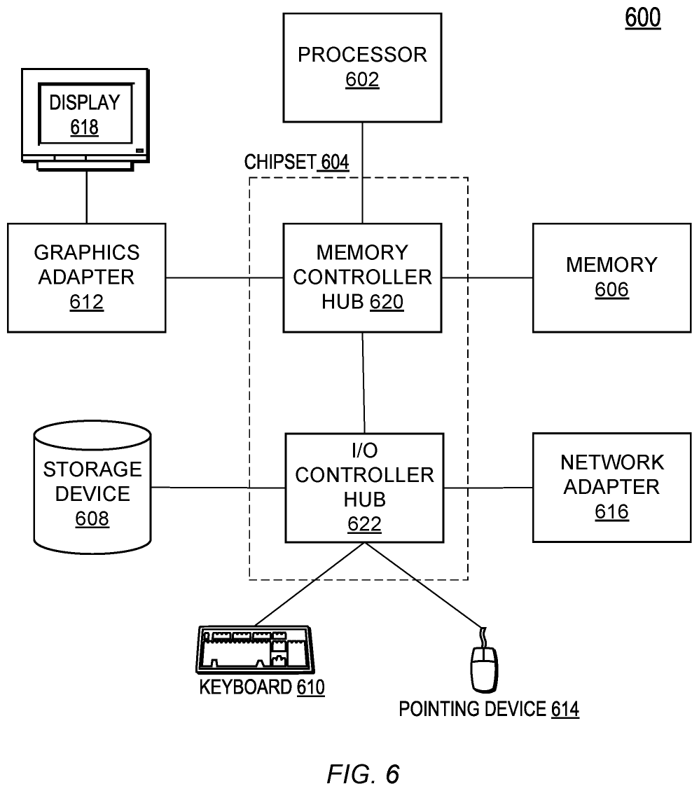

FIG. 6 is a block diagram illustrating physical components of a computer 600 used as part or all of the transportation management system 110, rider device 120, or driver device 130 from FIG. 1, in accordance with an embodiment. Illustrated are at least one processor 602 coupled to a chipset 604. Also coupled to the chipset 604 are a memory 606, a storage device 608, a graphics adapter 612, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is any non-transitory computer-readable storage medium, such as a hard drive, compact disk read-only memory (CD-ROM), DVD, or a solid-state memory device. The memory 606 holds instructions and data used by the processor 602. The graphics adapter 612 displays images and other information on the display 618. The network adapter 616 couples the computer 600 to a local or wide area network.

As is known in the art, a computer 600 can have different and/or other components than those shown in FIG. 6. In addition, the computer 600 can lack certain illustrated components. In one embodiment, a computer 600, such as a host or smartphone, may lack a graphics adapter 612, and/or display 618, as well as a keyboard 610 or external pointing device 614. Moreover, the storage device 608 can be local and/or remote from the computer 600 (such as embodied within a storage area network (SAN)).

As is known in the art, the computer 600 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 608, loaded into the memory 606, and executed by the processor 602.

A non-transitory computer readable medium, such as the storage device 608 stores instructions that when executed by a processor cause the processor to perform steps, such as those described with reference to FIG. 5 and elsewhere throughout this written description.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations while described functionally computationally or logically are understood to be implemented by computer programs or equivalent electrical circuits microcode or the like. Furthermore, it has also proven convenient at times to refer to these arrangements of operations as modules without loss of generality. The described operations and their associated modules may be embodied in software firmware hardware or any combinations thereof.

Any of the steps operations or processes described herein may be performed or implemented with one or more hardware or software modules alone or in combination with other devices. In one embodiment a software module is implemented with a computer program product comprising a computer-readable medium containing computer program code which can be executed by a computer processor for performing any or all of the steps operations or processes described.

Embodiments may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory tangible computer readable storage medium or any type of media suitable for storing electronic instructions which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process where the information is stored on a non-transitory tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description but rather by any claims that issue on an application based hereon. Accordingly, the disclosure of the embodiments of the invention is intended to be illustrative but not limiting of the scope of the invention which is set forth in the following claims.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed. The scope of protection should be limited only by the following claims.

What is claimed is:

1. A method for rerouting an off-route vehicle, the method comprising:
transmitting, to a client device associated with a driver of the vehicle, a route from an origin to a pick up location of a rider;
receiving location data from the client device, the location data indicating a current location of the vehicle;
determining, based on the location data and the provided route, one or more error values;
comparing the one or more error values to a threshold value for re-routing;
responsive to the one or more error values being greater than the threshold value and determining the current location of the vehicle is past the pick up location:
selecting a new pick up location; and
transmitting, to the client device associated with the driver, a new route to the new pick up location.

2. The method of claim 1 further comprising:
transmitting, to a client device associated with the rider, a route from a location of the rider to the new pick up location.

3. The method of claim 1, wherein before comparing the one or more error values to the threshold value for re-routing, the method comprises:
determining that the current location of the vehicle is within a threshold proximity of the drop off location; and
increasing the threshold value for re-routing.

4. The method of claim 3, wherein the threshold proximity of the drop off location is based on characteristics of the drop off location.

5. The method of claim 1, wherein the one or more error values are determined based on an error function, the error function depending on variables comprising a heading error and a position error.

6. The method of claim 5, wherein the heading error represents a difference in a direction of travel indicated by the location data from the client device and a direction of travel associated with the provided route.

7. The method of claim 5, wherein the position error represents a difference between an expected location and the current location of the vehicle.

8. The method of claim 1, wherein providing a re-route comprises:
determining a new route from current location data of the client device to the destination; and
transmitting the new route to the client device.

9. The method of claim 1, wherein a new pick up location is selected based on determining that the current location of the vehicle is within a threshold distance of the pick up location.

10. A method for rerouting an off-route vehicle comprising:
transmitting, to a client device associated with a driver of the vehicle, a route from an origin to a drop off location;
receiving location data from the client device, the location data indicating a current location of the vehicle;
determining, based on the location data and the provided route, one or more error values;
comparing the one or more error values to the threshold value for re-routing;
responsive to the current location of the vehicle being within a threshold proximity of the drop off location, increasing the threshold value for re-routing; and
responsive to the one or more error values being greater than the increased threshold value, transmitting, to a client device, a new route the current location of the vehicle to the drop off location.

11. The method of claim 10, further comprising:
transmitting, to the client device, a route from an origin to a pick up location; and
responsive to receiving location data indicating the vehicle has passed the pick up location:
selecting a new pick up location; and
transmitting, to the client device associated with the driver, a route to the new pick up location.

12. The method of claim 11, further comprising:
transmitting, to a client device associated with the rider, a route from a location of the rider to the new pick up location.

13. The method of claim 11, wherein a new pick up location is selected based on determining that the current location of the vehicle is within a threshold distance of the pick up location.

14. The method of claim 10, wherein the threshold proximity of the destination is based on characteristics of the drop off location.

15. The method of claim 14, wherein the characteristics of the drop off location include one or more metrics of how urban an area surrounding the drop off location is.

16. The method of claim 10, wherein the one or more error values are determined based on an error function, the error function depending on variables comprising a heading error and a position error.

17. The method of claim 12, wherein the heading error represents a difference in a direction of travel indicated by the location data from the client device and a direction of travel associated with the provided route.

18. The method of claim 10, wherein the position error represents a difference between an expected location and an actual location of the vehicle.

19. The method of claim 10, wherein the instructions for providing a re-route further comprise:
determining a new route from current location data of the client device to the destination; and
transmitting the new route to the client device.

20. A non-transitory computer readable medium storing instructions that, when executed by a processor, cause the processor to perform steps comprising:
transmitting to a client device associated with a driver of the vehicle a route from an origin to a pick up location of a rider;
receiving location data from the client device, the location data indicating a current location of the vehicle;
determining, based on the location data and the provided route, one or more error values;
comparing the one or more error values to a threshold value for re-routing;
responsive to the one or more error values being greater than the threshold value and determining the current location of the vehicle is past the pick up location:
selecting a new pick up location; and
transmitting, to the client device associated with the driver, a new route to the new pick up location.
